(19) United States
(12) Patent Application Publication
(10) Pub. No.: US 2010/0278979 A1
(43) Pub. Date: Nov. 4, 2010

(54) INTERLOCKING EDIBLE SIDELINER FOR CAKE DECORATION, METHOD, THREE-DIMENSIONAL CAKE SCULPTURE METHOD AND PRODUCT

(75) Inventor: Debra L. KOPLISH, Newfoundland, NJ (US)

Correspondence Address: MYERS WOLIN, LLC, 100 HEADQUARTERS PLAZA, North Tower, 6th Floor, MORRISTOWN, NJ, 07960-6834, US

(73) Assignee: SIGNED ORIGINALS, INC., Newfoundland, NJ (US)

(21) Appl. No.: 12/779,925

(22) Filed: May 13, 2010

Related U.S. Application Data
(63) Continuation-in-part of application No. 11/444,013, filed on May 31, 2006.
Application No. 11/444,013 is a continuation-in-part of application No. 10/635,350, filed on Aug. 6, 2003, now abandoned.

(51) Int. Cl. A23G 3/54

(52) U.S. Cl. 426/87; 426/138; 426/282

(57) ABSTRACT

An edible sideliner comprises a sheet of bakeable edible substrate formed into a continuous loop, the bakeable edible substrate having sufficient integrity to be freestanding when formed into a continuous loop so as to receive a bakeable substance within an area bounded by the continuous loop, the bakeable edible substrate being suitable to be baked onto a bakeable substance received within the area bounded by the continuous loop that is baked together with the bakeable edible substrate to formed a baked substance, wherein the bakeable edible substrate forms a baked-on sidewall of the baked substance after the bakeable substance is baked together with the bakeable edible substrate. The sideline may be an interlocking sideline form from a flat sheet of edible substrate.

### CROSS-REFERENCE TO RELATED APPLICATIONS

This is a continuation-in-part of U.S. application Ser. No. 11/444,013, filed May 31, 2006, now pending, which is a continuation-in-part of U.S. application Ser. No. 10/635,350, filed Aug. 6, 2003, now abandoned, the contents of each being incorporated by reference herein.

### FIELD OF THE INVENTION

One embodiment of the present invention relates to baked or bakeable products generally, and, more particularly, to baked or bakeable products having unique edible sideliners and bases, methods of assemblage and use, the edible liners preferably being baked onto a cake, for example, without the need to be peeled off prior to consumption, the liners being consumed together with the cupcake or muffin for example one bite at a time, and to three dimensional presentations of scenes, e.g. stylized busts, animals, holiday themes, and the like. Additional embellishments can be added to the top of the cupcake, muffin, & cake, for example, to enhance the overall look of the edible liner. The present invention is both the methods and the products, wherein, in some embodiments, liners are created flat and are shaped, connected and filled with cake material for cooking; in other embodiments, the top of the cupcake or cake has a three dimensional presentation and the side has a continuation of the presentation in two dimensions, the side being the edible liner that bakes onto the cake. If there is a need to peel the edible liners after baking, it is possible to do so but not necessary, since they are edible. In other preferred embodiments, the present invention is directed to interlocking edible cake sideliners, alone, with separate edible bases and with attached edible bases.

In certain embodiments the edible liner walls may be flavored or non-flavored, and can be manufactured flat and are shaped and connected. In other embodiments, a flat bottom disc can be manufactured separately and/or attached as an edible base. In one embodiment, the method comprises dropping a continuous loop edible liner into a greased or non-stick cupcake, muffin, or baking tin to form a bounded area, the continuous loop having sufficient integrity to be freestanding when formed into a continuous loop so as to receive a bakeable substance within an area bounded by the continuous loop. Thereafter a batter or other bakeable substance is placed or poured into the center of the tins bounded by the continuous loop liners. As the batter and liners bake according to a recipe, the edible continuous loop liners bake onto the cake walls and the liner may be consumed with the cake. There is no need to peel off the edible liner, but one may do so if desired. Decorations may be applied to the top of the baked product.

### BACKGROUND

The following patents relate to decorative baked products:

U.S. Pat. No. 2,895,832 describes a novelty cake comprising a baked cake having a recess in its upper surface, an edible sheet bearing an edible design applied on the surface of said sheet disposed in said recess, and a layer of transparent gelatin disposed over said sheet and filling most of the recess in said cake.

U.S. Pat. No. 3,503,345 describes a method for decorating a cake by pre-forming a disk of icing, freezing the disk so that it hardens to facilitate handling, and then placing it on the cake so that it softens to from the top of the cake.

U.S. Pat. No. 4,285,978 describes a method whereby decorative designs and the like can be formed upon baked goods by transferring a preprinted design from a transfer material to an uncooked dough surface. In one embodiment the dough surface is first covered with a thin layer of flour preparatory to transferring a water-soluble ink design to the dough. In a preferred embodiment after the dough is baked a liquid glaze is applied to the surface thereof for imparting a decorative and protective coating to the baked goods. The process of the invention is suitable for both hand and automated operation.

U.S. Pat. No. 5,035,914 describes a food for snack or as use as a breakfast cereal which has a creamy orange flavor. The food product includes a popped cereal which is selected from oat, wheat, rye, soy, corn, rice and combinations of these and essentially includes a powdered dairy or dairy substitute product which simulates cream flavor in combination with powdered orange or artificial orange flavor. Preferred embodiments include sweeteners such as fructose, sugar, corn syrup, dextrose, artificial sweeteners and combinations of these. Further, the food may include preservatives as well as vitamin and mineral supplements. In one embodiment, the puffed cereal is formed in a shape of a sphere.

U.S. Pat. No. 5,534,281 describes an apparatus and a method for making printed foods such as cookies, crackers, and snacks at high production speeds on a continuous basis. The apparatus includes a rotary printer which is synchronized with dough forming apparatus such as a rotary cutter or rotary molder.

U.S. Pat. No. 6,295,758 describes a wrapper for wrapping about a floral grouping and a method for wrapping the floral grouping, the wrapper having a handle formed from a portion of the sheet of material for carrying the wrapper with the floral grouping disposed therein. The wrapper may comprise one or more sheets of material. The sheet may have more than one handle portion formed thereon.

U.S. Pat. No. 6,432,461 describes an edible cake decoration comprising a sugarpaste formulation including at least one humectant. A method of forming the decoration is also disclosed which includes exposing the sugarpaste to a humid environment. An apparatus for use in the method is also disclosed which comprises a blister having a profiled surface and plurality of ventilation holes therein, which blister forms a template for use in the vacuum forming of the wet sugarpaste to provide a 3-D shape to the decoration, the sugarpaste being dried after vacuum forming.

U.S. Pat. No. 6,432,462 describes edible decorations which reproduce all types of patterns, including colored patterns. The purpose of these decorations is partially or totally to cover the cakes for which they are intended and with which they form a perfectly homogenous whole. More precisely, the invention comprises in producing a printed decoration with five successive layers: a first layer of printed edible paper, and a second layer of material for modifying the texture of the edible paper and sticking the first and third layers together. The third layer comprises of a material belonging to the group comprising almond paste and chocolate. The fourth layer is equivalent to the second layer, and the fifth layer is equivalent to the first layer. By virtue of this innovation, a printed decoration does not detract from the cake and remains supple and homogenous.

Notwithstanding the prior art, the present invention is neither taught nor rendered obvious thereby.

### SUMMARY

In some embodiments, the present invention is a three dimensional cake sculpture product. The term “cake sculpture” refers to any cake that has a sculpture presentation. “Cake” means a product that is made from batter and is baked. In other embodiments, the present invention is an interlocking cake sideliner, alone or with a separate bottom or an attached bottom.

Flexible wafer-like edible sideliners, preferably formed into continuous loops, are suited to support the pouring of the cake batter, baking, and finally becoming a part of the cake itself. The liners can preferably accommodate edible inks to illustrate any design. Edible continuous loop liners, which can be flavored or unflavored, permits creativity to be simple and since they are edible there is no waste, which makes for a “green” Earth friendly product.

In some preferred embodiments, the present invention interlocking cake sideliner includes a flat sheet of bakeable edible substrate, being a sideliner having at least four sides, including a top edge, a bottom edge, a first end and a second end, the first end having a first interlocking member and the second end having a second interlocking member that is interlockable with the first interlocking member. In some preferred embodiments, the interlocking cake sideliner flat sheet has a general footprint shape, excluding the interlocking members, selected from the group consisting of rectangular, trapezoidal, parallelogram, and curved top and bottom trapezoidal.

In some preferred embodiments, the flat sheet has a first interlocking member that is one of a male and a female member and the second end having a second interlocking member that is the other of a male and a female member and is interlockable with the first interlocking member to form a continuous loop. The male and female interlocking members can exhibit varying shapes and sizes in addition to those illustrated herein. In other embodiments, the flat sheet is formed into a continuous loop during the manufacturing process and is non-interlocking.

In some preferred embodiments, the flat sheet has a thickness of about 1/100 inch to about ⅜ inch, and preferably about 1/20 inch to about ⅛ inch and is made of a material selected from the group consisting of flatbread, crepe, pancake, wafer, sugar wafer, rice paper, pie crust, pita, cornmeal, unleavened bread.

In some preferred embodiments, the flat sheet has a distinguishable scene printed thereon in bakeable edible print. For any prints or designs, any known edible dye or food coloring may be used. Such inks include any certified United States Food & Drug Administration food colorings.

In some preferred embodiments, the flat sheet has a distinguishable scene printed thereon in bakeable edible print, and the sideliner further includes edible topping decoration that is complimentary to the distinguishable scene. In some preferred embodiments, the interlocking cake sideliner further includes a separate flat sheet of bakeable edible substrate bottom having a shape and size compatible with an open bottom created when the wherein the flat sheet sideliner ends are interlocked with one another. In some preferred embodiments, the flat sheet sideliner and the bottom have interlocking features that are complimentary. In some preferred embodiments, the interlocking cake sideliner further includes a connected flat sheet of bakeable edible substrate bottom having a shape and size compatible with an open bottom created when the wherein the flat sheet sideliner ends are interlocked with one another. The flat sheet sideliner and the bottom preferably have interlocking features that are complimentary.

Certain embodiments of the present invention also include a method of making a cake product comprising:

a.) providing a flat sheet of bakeable edible substrate, being a sideliner having at least four sides, including a top edge, a bottom edge, a first end and a second end, the first end having a first interlocking member and the second end having a second interlocking member that is interlockable with the first interlocking member to form a continuous loop;

b.) interlocking the sideliner to form a continuous loop and placing it on a bakeware device;

c.) pouring bakeable cake material into the sideliner on the bakeware device and baking until baked such that the edible liner bakes right onto the cupcake, muffin, cake, or baked good, becoming one and being consumable with the cake wherein the edible liner bites off with each bite of the cake. In some preferred embodiments, the method is wherein the flat sheet has a general footprint shape, excluding the interlocking members, selected from the group consisting of rectangular, trapezoidal, parallelogram, and curved top and bottom trapezoidal. In some preferred embodiments, each of the features of the product set forth above, separately or in combination, are included in the method.

In some preferred embodiments, the present invention product includes: a.) an edible baked base having a bottom, substantially vertical walls, and a top; and, b.) an edible three dimensional sculpture presenting a distinguishable scene, the sculpture has two portions, being a first portion and a second portion. The first portion is three dimensional and is located on the top of the base, and the second portion is two dimensional and is located on the substantially vertical walls of the base. In some preferred embodiments, the second portion includes at least one edible substrate and at least one edible printed segment of the distinguishable scene on the substrate.

In some preferred embodiments of the present invention three dimensional cake sculpture product, the first portion is selected from the group consisting of cake icing, cookies, wafers, jelly beans, candy and combinations thereof positioned to create a segment of the distinguishable scene.

In some preferred embodiments, the distinguishable scene is a head presentation of a stylized person, e.g., a head presentation of a stylized person including a top as the first portion and facial features as the second portion. The top may be selected from the group of three dimensional tops, consisting of hair, ears, headwear and combinations thereof.

In other embodiments of the present invention three dimensional cake sculpture product, the distinguishable scene is at least a part of a stylized animal.

In other embodiments, the present invention three dimensional cake sculpture product includes an edible baked base and a three dimensional sculpture presenting a distinguishable scene, the sculpture being of two portions, the first portion being edible and being three dimensional and being located on the top of the base, and the second portion being inedible and being two dimensional and being located on the substantially vertical walls. In some embodiments, the second portion includes at least one inedible substrate and at least one inedible printed segment of the distinguishable scene on the substrate.

One embodiment of the present invention also relates to a method of making a three-dimensional cake sculpture product (“cake” means any cake product, including cupcake). The method includes the steps of a.) making an edible baked base in a shape having a bottom, substantially vertical walls and a top; and b.) creating a three dimensional sculpture of a distinguishable scene on the base by applying a first portion of the sculpture to the top of the base in the form of a three dimensional portion of the sculpture, and applying a second portion of the sculpture to the substantially vertical walls in a flat, smooth, two dimensional outer surface. In some embodiments, the second portion is an edible portion having an edible substrate and at least one edible printed segment of the distinguishable scene on the substrate. In other embodiments, the second portion is an inedible peelable portion containing at least one printed segment of the distinguishable scene.

For example, the methods may include the sculpture being created by applying at least one application of cake icing and at least a second application of a decoration selected from the group consisting of another cake icing, cookies, wafers, jelly beans, candy and combinations thereof. The edible baked base may be made by baking in a baking pan having a predetermined shape to create the bottom of the substantially vertical walls, and the non-vertical top or it could be cut or shaped after being baked.

### BRIEF DESCRIPTION OF THE DRAWINGS

The present invention should be more fully understood when the specification herein is taken in conjunction with the drawings appended hereto wherein:

FIGS. 1, 2, 3, and 4 show a front view of various children's busts in the form of sculptured cake;

FIGS. 5, 6, 7, and 8 show present invention cakes with sculptured animal presentations;

FIGS. 9, 10, 11, 12, 13, 14, 15, and 16 illustrate present invention sculptured cakes with holiday themes, including 4th of July, Halloween, Christmas, Easter, and Thanksgiving;

FIG. 17 shows a happy clown birthday present invention sculptured cake;

FIG. 18 shows present invention sculptured cake in the form of an animal with horns;

FIGS. 19, 20, 21, and 22 show present invention sculptured cupcakes with smiling children;

FIGS. 23, 24, 25, 26, 27, 28, 29, and 30 show various sculptured animal cakes;

FIGS. 31 and 32 show a porpoise and a crab underwater as present invention sculptured cakes;

FIGS. 33, 34, 35, and 36 show sculptured animal cakes;

FIGS. 37 and 38 show sculptured Halloween scary cakes;

FIGS. 39, 40, 41, 42, and 43 illustrate sculptured anima cakes;

FIG. 44 shows a vampire sculptured cake;

FIGS. 45, 46, 47, 48, 49, and 50 illustrate various pests and bugs as sculptured cakes;

FIGS. 51 and 52 show fire truck and train action three dimensional cake sculptures;

FIGS. 53 and 54 illustrate three dimensional sculptured sport cakes;

FIGS. 55 and 56 illustrate present invention cakes with children's fantasy sculpture;

FIGS. 57, 58, 59, and 60 show three dimensional sports cupcakes;

FIGS. 61, 62, 63, 64 and 65 show front views of certain embodiments of interlocking sideliners in full or partially cut views, such sideliners being edible liners baked onto a cupcake, cake, muffin or the like.

FIGS. 66 through 69 show various views and components of some embodiments of a present invention interlocking sideliner with a separate, insertable bottom member;

FIG. 70 shows a front view of one embodiment of a present invention edible bakeable interlocking sideliner with an attached bottom member and with repeated print design thereon; and,

FIGS. 71 and 72 show front views of two additional embodiments of a present invention interlocking sideliner with different shapes and printed designs thereon.

The liners create endless design opportunities and this showcases the product being an edible liner that bakes onto the cake, cupcake, muffin, or baked good.

### DETAILED DESCRIPTION OF THE PREFERRED EMBODIMENTS

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

Certain embodiments of the present invention cupcakes and cakes present exciting sculptures to children and adults in a new form never before used. The baked cakes have flat (two dimensional) printed presentations on their sides resulting from the baking on of an edible sideliner during the baking of the cakes, which edible sideliner bakes onto the cake and can be eaten with the cake or peeled if desired, and three dimensional accenting sculptures on their tops wherein the tops and sides together may complete a single scene. Now that the invention has been disclosed, an infinite number of possibilities emerge. The following examples illustrate certain aspects and embodiments of the present invention.

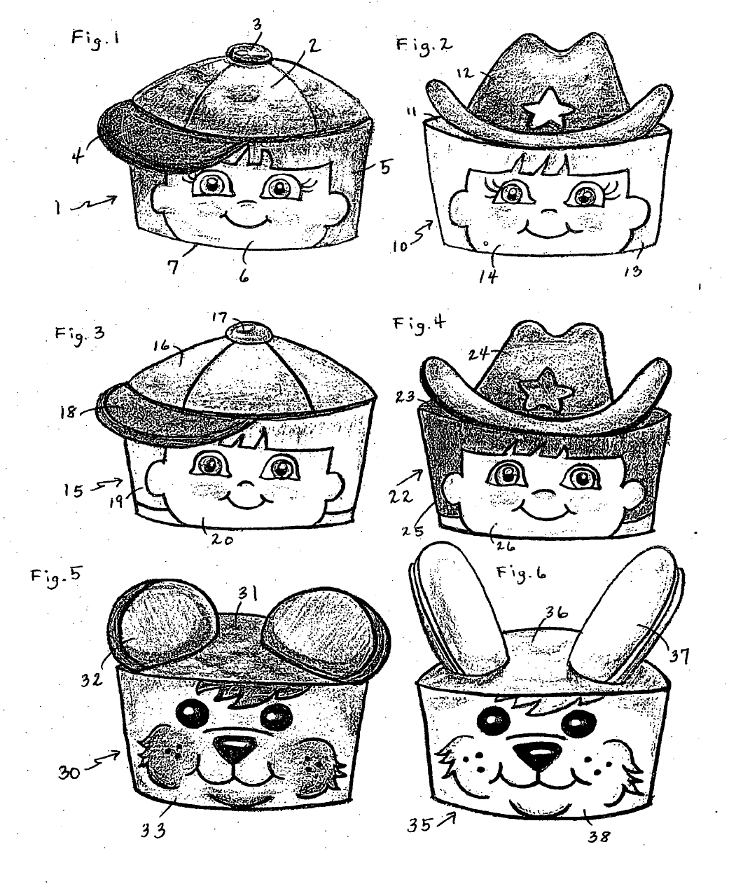

FIG. 1 shows one embodiment of a sculptured cake 1 with a child's head with a baseball cap. Sculptured cake 1 has a top 2 in the form of a three dimensional baseball cap made of frosting. It includes jelly bean button 3 and a cookie visor 4. The sidewall 5 has a printed paper wrap with face 6 printed thereon. It extends from top 2 down to bottom 7. In this embodiment, the sidewall 5 is inedible, although it could readily be an edible film wrap with edible film print thereon. Edible film is well known for dissolvable mint strips and edible print has been used on lollipops for decades. In a preferred embodiment, the sidewall 5 is an edible sideliner that is pre-decorated with the face 6 and baked onto the cake 1.

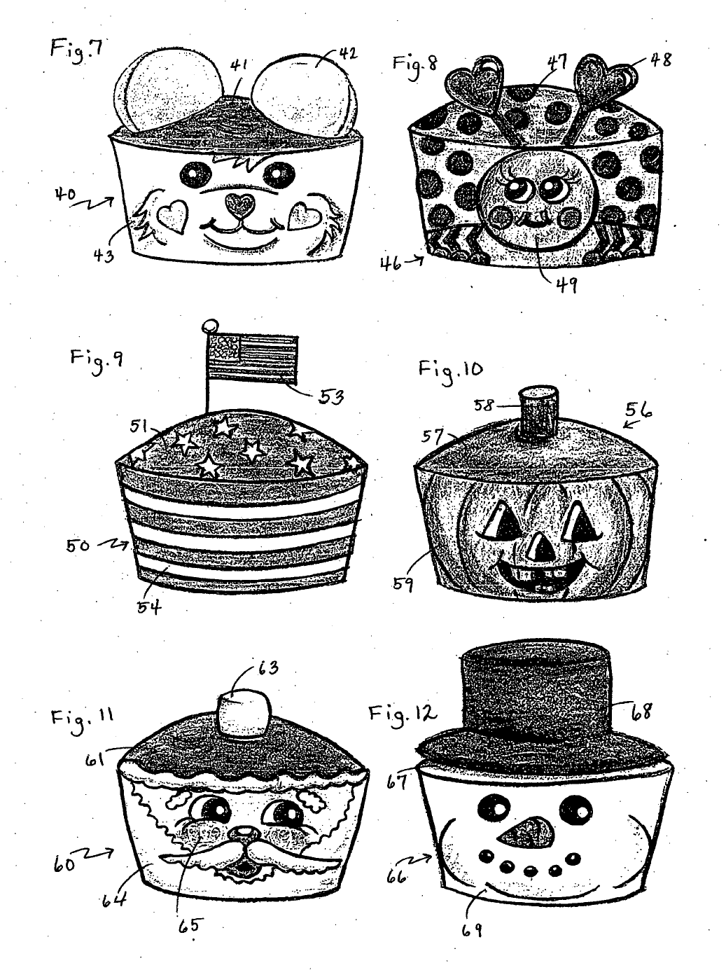

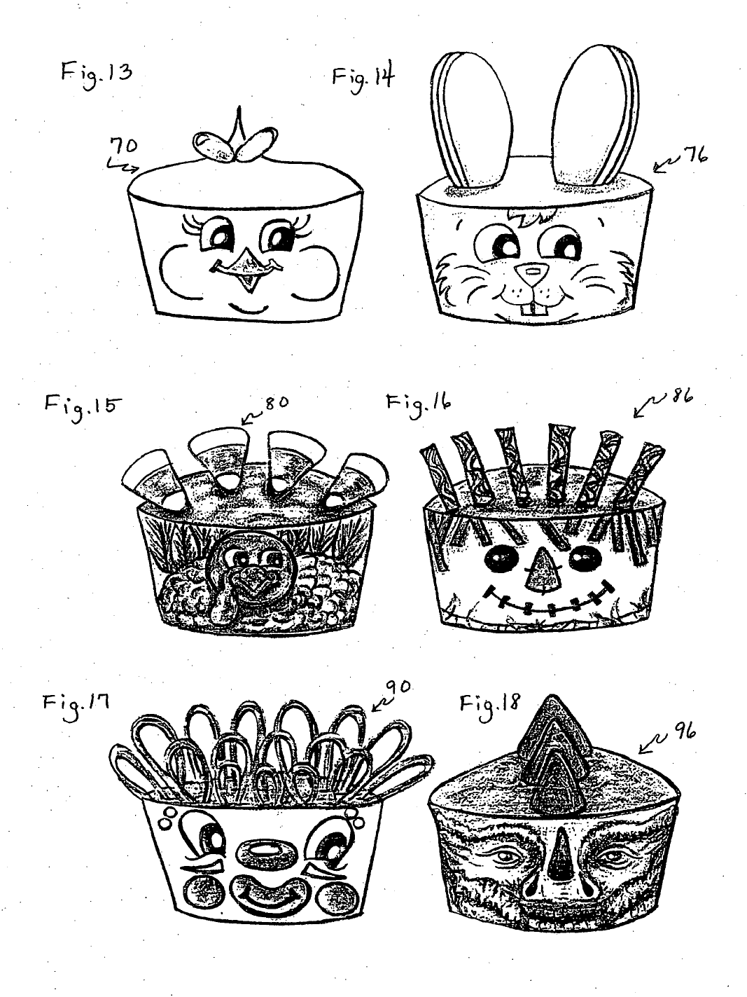

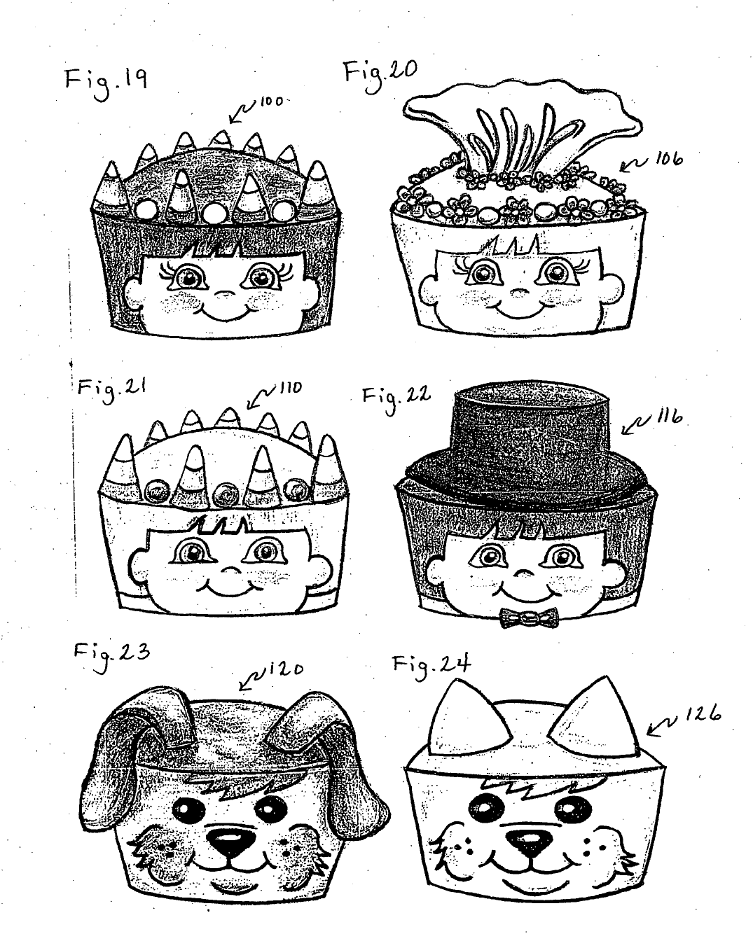

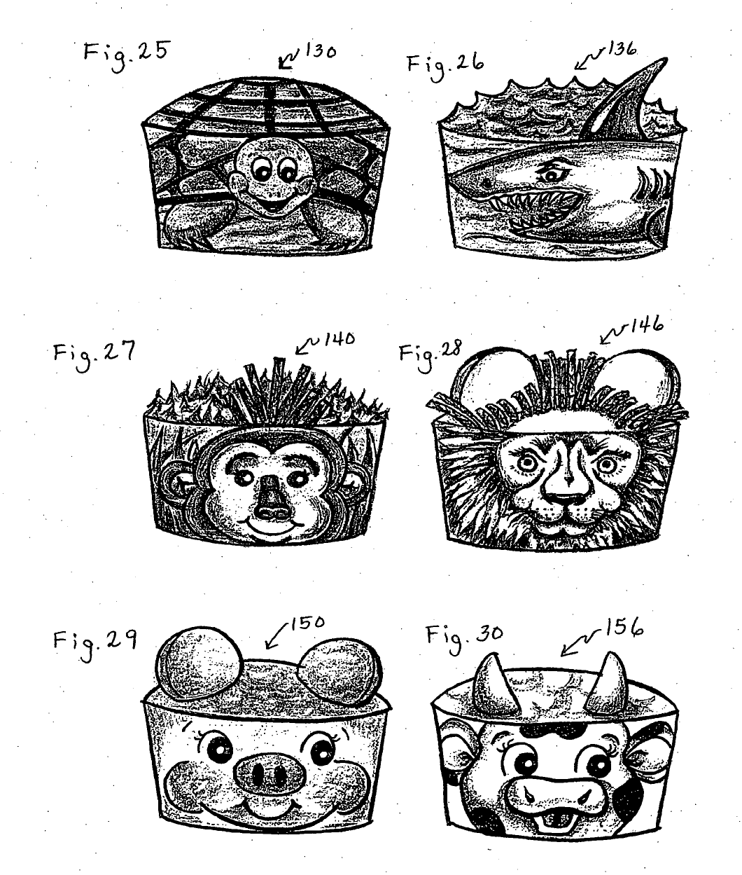

FIG. 2 shows one embodiment of a sculptured cake 10 with a molded sheriffs hat 12 on top 11 and an edible face 14 on substantially vertical sidewall 13. In a preferred embodiment, the sidewall 13 is an edible sideliner that is pre-decorated with the edible face 14 and baked onto the cake 10.

FIG. 3 shows one embodiment of a sculptured cupcake 15 with top 16 in the form of blue molded frosting with a butter rum button 17 and a cookie visor 18. Sidewall 19 includes a face representation 20. In a preferred embodiment, the sidewall 19 is an edible sideliner that is pre-decorated with the face representation 20 and baked onto the cupcake 15.

FIG. 4 shows one embodiment of another sculptured cake 22 with a top 23 and a sheriffs hat 24, with an edible strip 25 with a printed child's face and hair 26. In a preferred embodiment, the edible strip 25 is an edible sideliner that is pre-decorated with the face representation 26 and baked onto the cake 22.

FIG. 5 shows one embodiment of a sculptured cake dog 30 with cookie ears 32 on top 31 and a dog face on sidewall printed sheet 33. In a preferred embodiment, the sidewall 33 is an edible sideliner that is pre-decorated and baked onto the cake 30.

FIG. 6 shows one embodiment of a sculptured cake dog 35 with cookie ears 37 on top 36 and a dog face on sidewall printed sheet 38. In a preferred embodiment, the sidewall sheet 38 is an edible sideliner that is pre-decorated and baked onto the cake 35.

FIG. 7 shows one embodiment of a valentine's cub sculptured cake 40 with top 41 and ears such as cookie 42, and sidewall printed sheet 43. In a preferred embodiment, the sidewall sheet 43 is an edible sideliner that is pre-decorated and baked onto the cake 40.

FIG. 8 shows one embodiment of a sculptured cake 46 with top 47 and heart antennas 48, and with printed edible sidewall sheet 49 to collectively create a ladybug. In a preferred embodiment, the sidewall sheet 49 is an edible sideliner that is pre-decorated and baked onto the cake 46.

FIG. 9 shows one embodiment of a cupcake 50 with stars and a blue background top 51 with flag 53. Sidewall 54 includes a printed edible gel sheet 54 with red and white flag stripes. In a preferred embodiment, the sidewall sheet 54 is an edible sideliner that is pre-decorated and baked onto the cupcake 50.

FIG. 10 shows one embodiment of a sculptured cake pumpkin 56 with top 57 having a stem 58 (e.g. a root beer barrel) and sidewall 59 in the form of an edible pumpkin face. In a preferred embodiment, the sidewall 59 is an edible sideliner that is pre-decorated and baked onto the cake 56.

FIG. 11 shows one embodiment of a sculptured cake Santa 60 with top hat 61 and marshmallow 63 and a sidewall 64 that is an edible film with a Santa face 65 printed thereon. In a preferred embodiment, the sidewall 64 is an edible sideliner that is pre-decorated and baked onto the cake 60.

FIG. 12 shows one embodiment of a sculptured cake snowman 66 with top 67 and candy molded top hat 68 and a printed sidewall sheet 69 with a snowman face printed thereon. In a preferred embodiment, the sidewall sheet 69 is an edible sideliner that is pre-decorated and baked onto the cake 66.

FIGS. 13, 14, 15, 16, 17, 18, 19, 20, 21, 22, 23, and 24 show various embodiments of sculptured cakes 70, 76, 80, 86, 90, 96, 100, 106, 110, 116, 120, and 126 respectively, all showing various sculptured presentations with sidewall sheets with two dimensional printing and tops with three dimensional sculptured creations utilizing such edibles as molded or shaped icing, jelly beans, wafers, candy corns, pretzel sticks, string candy, chocolate kisses, flowers, beads and other edible components. It is preferred that the sidewall sheets are edible sideliners that are pre-decorated and baked onto the cakes.

FIGS. 25-30 show various embodiments of sculptured cakes 130, 136, 140, 146, 150, and 156 respectively, all showing various sculptured presentations with animal sideliners that are preferably edible sideliners that are baked onto the cakes.

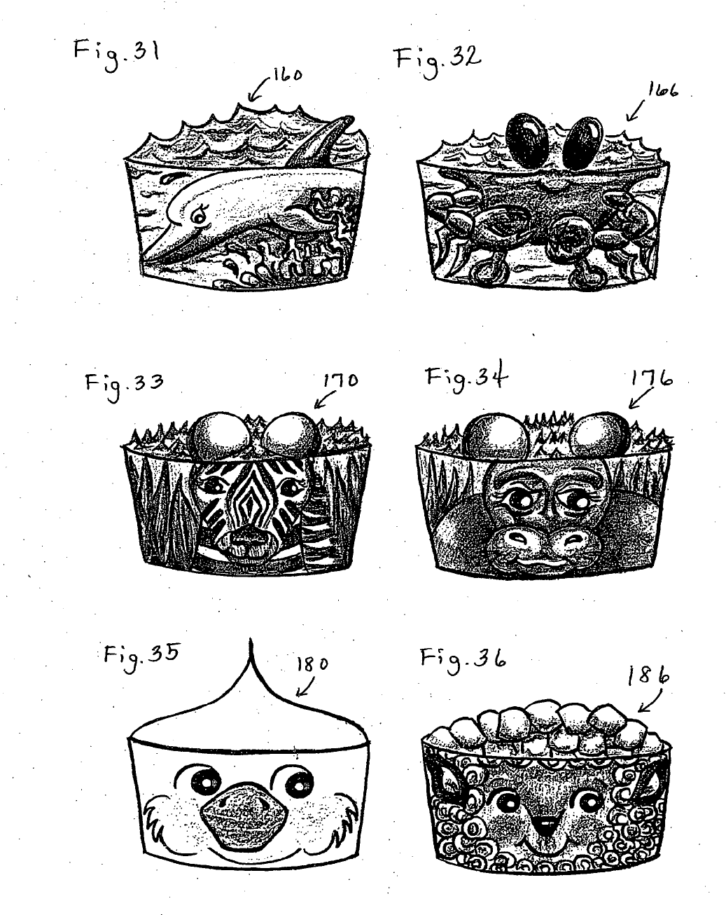

FIGS. 31-36 show embodiments of sculptured cakes 160, 166, 170, 176, 180 and 186 respectively of various animals.

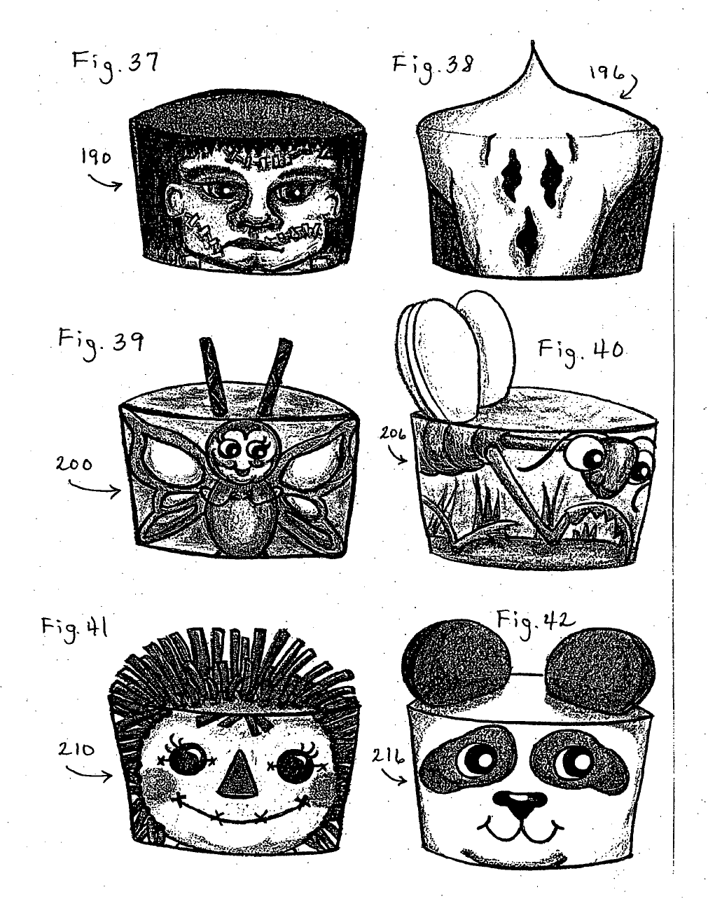

FIGS. 37 and 38 show embodiments of sculptured cakes 190 and 196 of Halloween scary designs.

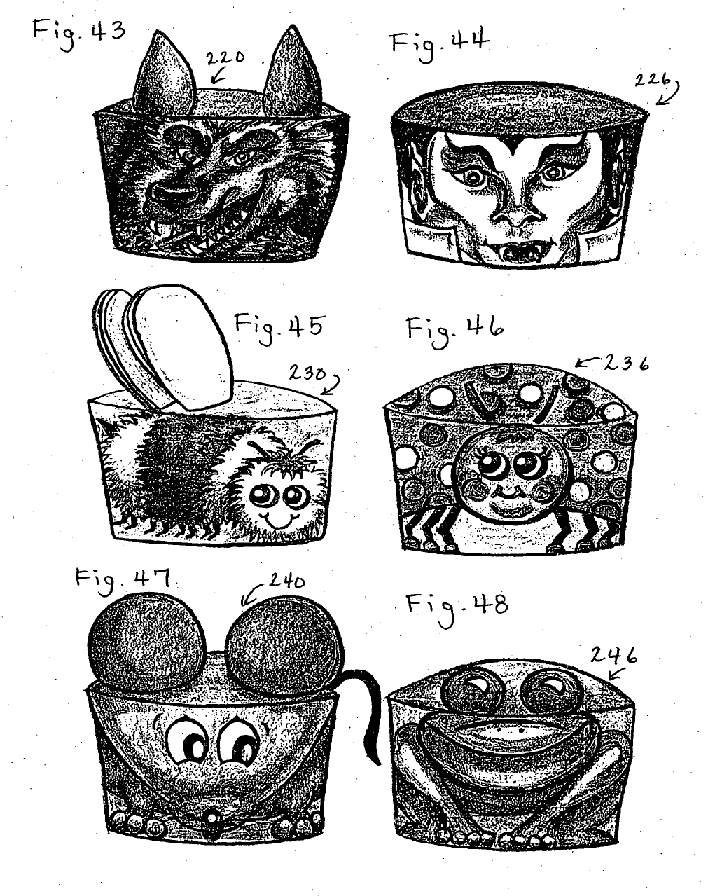

FIGS. 39-43 show embodiments of sculptured cakes 200, 206, 210, 216, and 220 respectively of various animals.

FIG. 44 shows one embodiment of a sculptured cake 226 of a vampire.

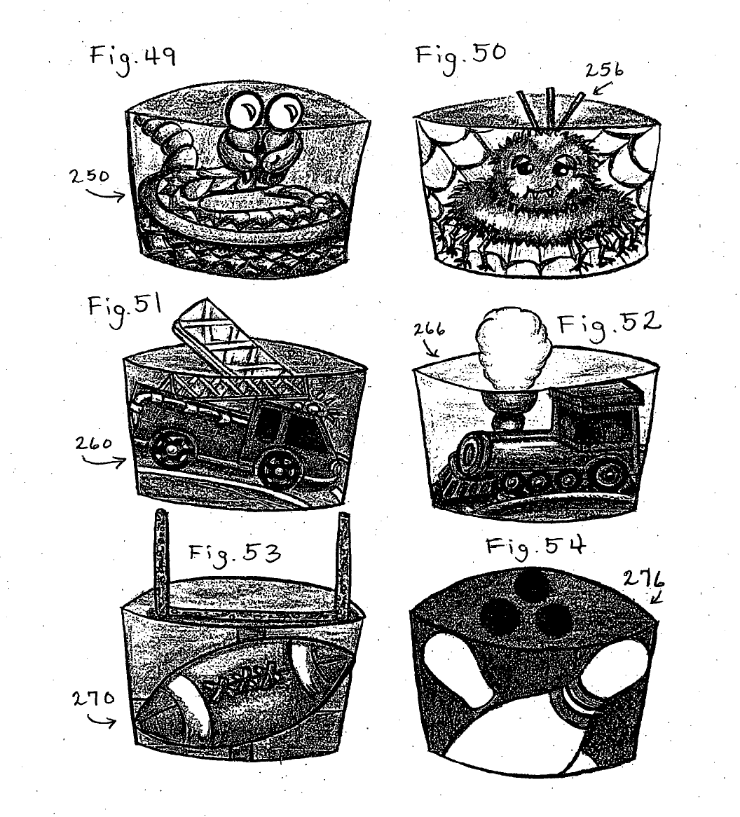

FIGS. 45-50 show embodiments of sculptured cakes 230, 236, 240, 246, 250, and 256 respectively of various pests and bugs.

FIGS. 51 and 52 show embodiments of sculptured cakes 260 and 266 of a truck and train engine, respectfully.

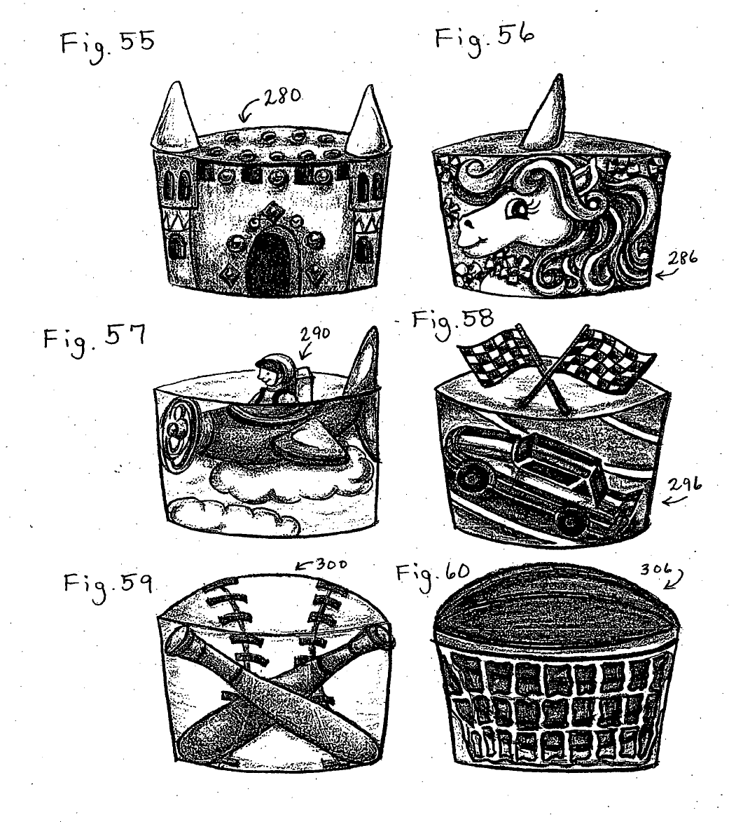

FIGS. 53 and 54 show embodiments of three dimensional sculptured cakes 270 and 276 of various sports.

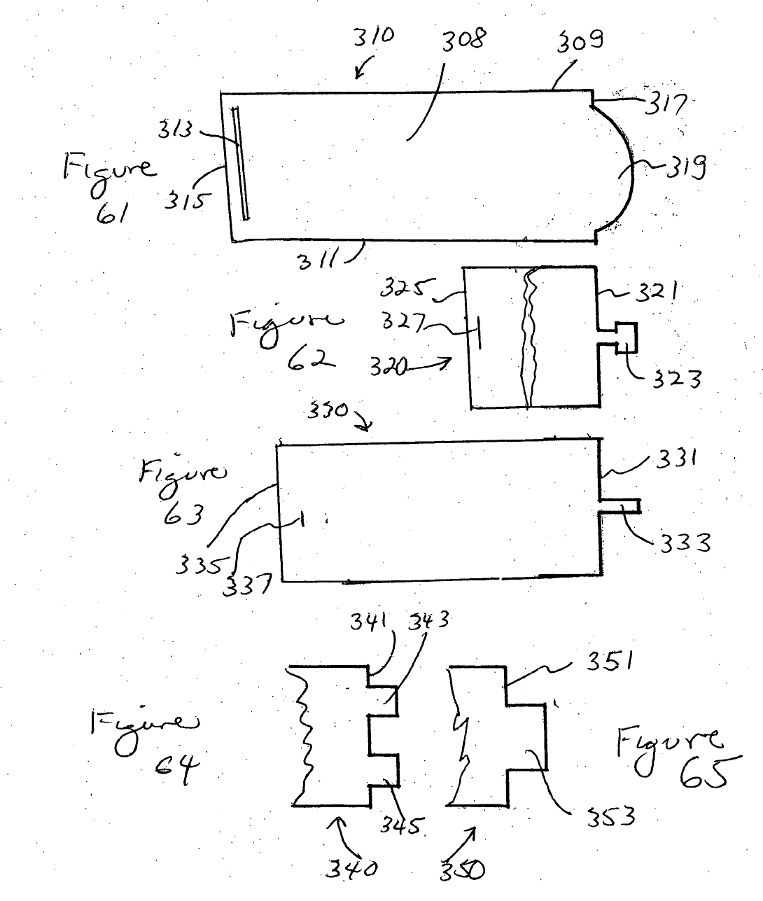

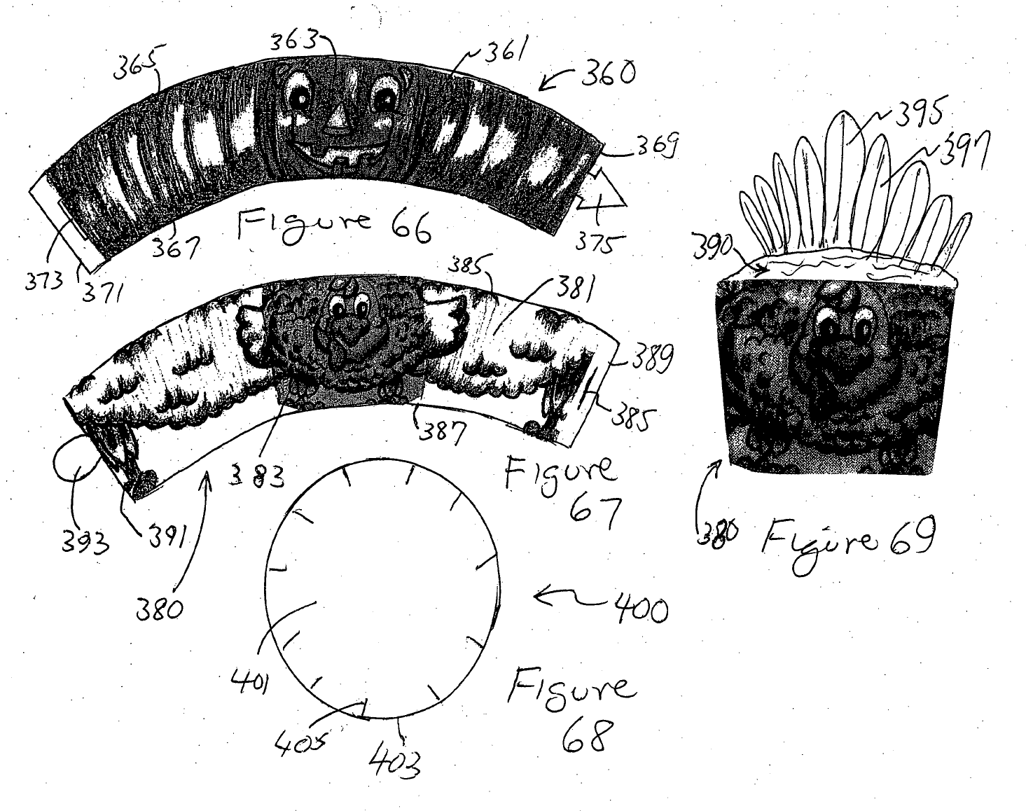

FIGS. 55 and 56 show embodiments of sculptured cakes 280 and 286 of various children's fantasies.

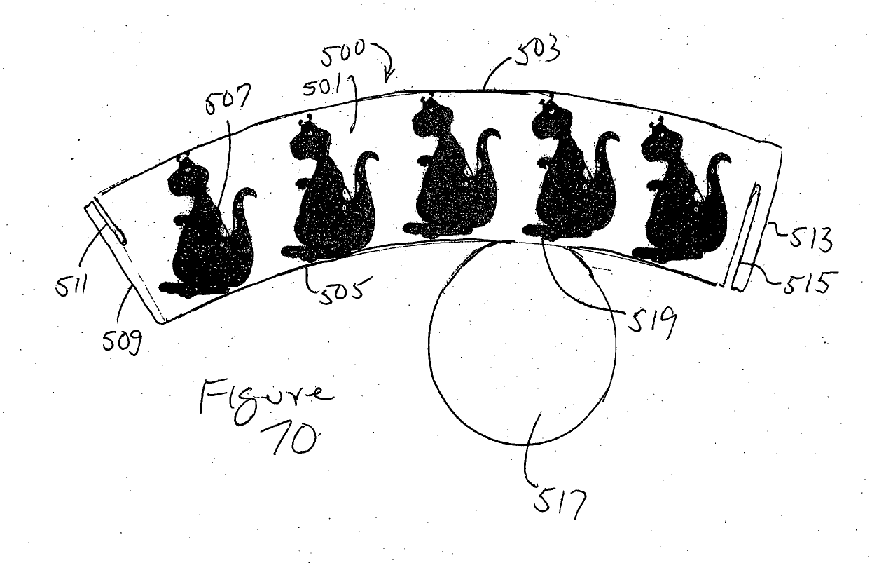

FIGS. 57-60 show embodiments of three dimensional sculptured cupcakes 290, 296, 300, and 306 respectively of various sports.

In each of the embodiments described above, the various artistic designs that line the sides of the cakes are preferably formed from edible liners that become part of the cake as they bake onto the cake during the baking process. Such edible sideliners are preferably interlocking or continuous loop edible liners.

FIGS. 61-65 show front views embodiments of interlocking edible sideliners in full or partially cut views. These sideliners are inserted into baking trays, and preferably cupcake or muffin trays, and bound an area in which is poured a batter or other baking good therein. The edible sidelines are formed as a single, continuous loop or are interlocking to form a continuous loop and are preferably made of a flat sheet of bakeable edible substrate being a sideliner having at least four sides, including a top edge, a bottom edge, a first end and a second end, said first end having a first interlocking member and said second end having a second interlocking member that is interlockable with said first interlocking member. The bakeable edible substrate preferably has sufficient integrity to be freestanding when formed into a continuous loop so as to receive and preferably contain a bakeable substance within an area bounded by the continuous loop. The edible liners and cake batter (or the like) are baked together with the edible liner becoming part of the baked cake and preferably forming a sidewall of the baked cake. The liners bake onto the cake and can be eaten with the cake or peeled off if desired.

FIG. 61 shows one embodiment of a flat rectangular sideliner 310 that is a sheet 308 with top and bottom edges 309 and 311, a first end 317 with a first interlocking member 319, being a male portion, and a second end 315 with a second interlocking member 313, being a female member. This sideliner 310 may be shaped with creases into a square, a rectangle or even a triangle, or it may be curved into a continuous loop, with member 319 being inserted into female member 313. The sideliner may be inserted into a baking tray and filled and baked and will be edible after baking, wherein the sideliner becomes part of the cake or baked good.

The below described non-limiting examples of sideliner embodiments are similarly assembled and the process is not repeated for each embodiment as assemblage and usage, just having been described, is now self-evident.

FIG. 62 shows one embodiment of a flat rectangular sideliner 320 with a first end 321 with a first interlocking member 323, being a male buckle portion, and a second end 325 with a second interlocking member 327, being a female slot member.

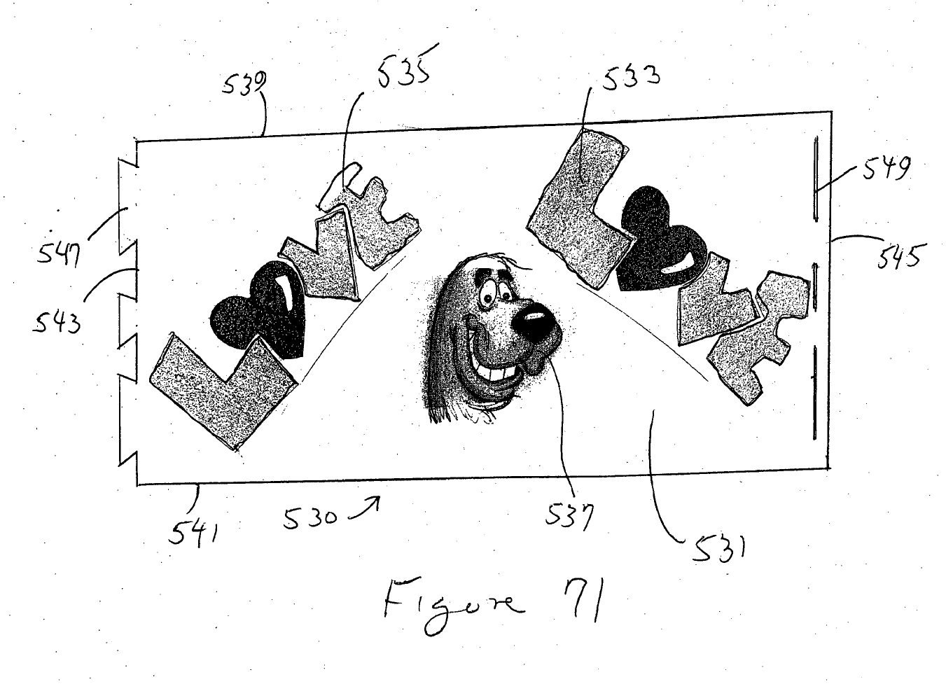

FIG. 63 shows one embodiment of a flat rectangular sideliner 330 with a first end 331 with a first interlocking member 333, being a straight male buckle portion, and a second end 335 with a second interlocking member 337, being a female slot member. FIG. 64 shows an alternative embodiment sideliner 340 partial view with male member double buckles 343 and 345 at end 431, and FIG. 65 shows an alternative embodiment sideliner 350 partial view with a large male buckle 353 at end 351.

FIGS. 66 through 69 show various views and components of certain embodiments of an interlocking sideliner with a separate, insertable bottom member. FIG. 66 shows one embodiment of a flat curved rectangular Halloween sideliner 360 that is an edible sheet 361 with top and bottom edges 365 and 367, a first end 369 with a first interlocking member 375, being a male portion, and a second end 371 with a second interlocking member 373, being a female member. This sideliner 360 may be shaped into a continuous loop, with member 319 being inserted into female member 313 so as to create a pumpkin presentation with edible print 363 showing the pumpkin design.

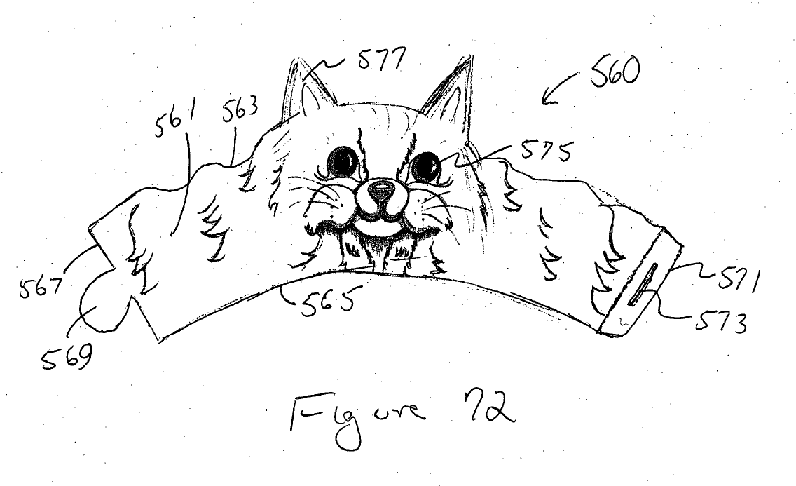

FIG. 67 shows one embodiment of a flat curved rectangular turkey sideliner 380 for Thanksgiving that is an edible sheet 381 with top and bottom edges 385 and 387, a first end 389 with a first interlocking member 355, being a female portion, and a second end 391 with a second interlocking member 393, being a tab male member. This sideliner 380 may be shaped into a continuous loop, with member 393 being inserted into female member 385 so as to create a pumpkin presentation with edible print 383 showing the turkey design, as shown in FIG. 69. The bottom insert 400, shown in FIG. 68, has a solid area 401 and an outer edge 403 with slits, serrations or ridges so that the insert 400 has a slightly larger diameter than the inside of sideliner diameter when interlocked as in FIG. 69 so that the insert 400 may be pushed into the interlocked sideliner 380 and the periphery will yield to create holding force. The result is an edible, bakeable cup that is filled with cake batter and baked, and the edible bakeable cup becomes part of the cake during the baking process. Also shown in FIG. 69 are turkey tail feathers 395, 397, etc. that are made of the same material as the sideliners and are also edible and bakeable, and bakes onto the cake.

FIG. 70 shows a front view of one embodiment of an edible bakeable interlocking sideliner 500 with an attached bottom member 517 attached at area 519 and typically formed integrally as part of the product. Flat sheet, curved edge, rectangular sideliner 500 has top and bottom edges 503 and 505, a first end 509 with a first interlocking member 511, and a second end 513 with a second interlocking member 515. This sideliner 500 is shaped into a continuous loop, with member 511 and 515 being hooked into one another. The bottom is then folded up to meet the bottom periphery of the sideliner 500 and it is placed on a baking pan or tray, filled with cake batter or the like and baked, resulting in the sideliner 500 and bottom member 517 becoming one with the baked cake.

FIGS. 71 and 72 show front views of two additional embodiments of interlocking edible sideliners with different shapes and printed designs thereon. In FIG. 71, sideliner 530 has top and bottom edges 539 and 541, a first end 543 with first interlocking members 547, and a second end 545 with second interlocking members 549, being female members. This sideliner 530 has printed edible character and word representations 533, 535 and 537, as shown, and is shaped into a continuous loop, with members 547 and 549 being interconnected with one another. In FIG. 72, kitten sideliner 560 has top and bottom edges 563 and 565, a first end 567 with first interlocking member 569, and a second end 571 with second interlocking member 573, being female members. This sideliner 560 has an arcuate top and bottom and when assembled takes the shape of a typical cupcake, i.e., a truncated inverted cone. It also has a printed kitten character 575 and upwardly extending ears, i.e. ear 577, as shown. It is shaped into a continuous loop, with interlocking members 569 and 573 being interconnected with one another.

Various non-limiting embodiments of flexible, flat, edible, bakeable sideliners, flavored or un-flavored, that become part of the cake once baked, have now been described in detail above. The following non-limiting examples of recipes may be used to create edible sideliners. While in some cases the recipes appear typical, they have more or less been modified or supplemented to be more flexible than conventional cookie, Asian pancake, etc. recipes, in some instances.

Sugar Cup Wafers (Like a Sugar Cone) Partially Baked in Flat Sheets

Ingredients:
100% Light wheat flour (bread flour)
40% Powdered sugar
1% Liquid lecithin
10% Double refined oil
0.2% Salt
QS Flavoring substance (i.e. powdered vanilla)
QS Coloring substance (liquid caramel)
100% Water

All ingredients are based on percentage points of wheat flavor weight.

Directions:
Combine all dry ingredients. Add water and mix thoroughly with a mixer (egg beater) on low speed until the batter is “smooth.” Then add double refined oil. If liquid lecithin is used, pre-mix it thoroughly with the oil or before adding to the other ingredients.

Recipe determines: When eggs are added to the batter, the wafer product will become more spongy and its taste will be improved. 2 eggs per Kg of flour.

Use batter within 1-2 hours.

This will produce 1 Kg of finished sheets. Sheets will be baked at 350 degrees for 15 minutes

Wafer Sheet Batter (Par-Baked in Flat Sheets)

Ingredients:
7.5 Kg Wheat flour
150 gms Maize starch
100 gms Powdered sugar
180 ml Fat
20 gms Soy lecithin liquid
40 gms Sodium bicarbonate and Ammonium bicarbonate (3:1)
2 gms Sodium metabisulphide
20 gms Salt
12 Litres Water

Directions:
Put the water in a mixer.
Add soy lecithin liquid, sodium bicarbonate and ammonium bicarbonate (3:1) and salt.
Start the mixer, add the starch and then slowly add small quantity of flour in intervals.
After the wheat flour is fully mixed, add the fiat and lecithin emulsion (preferably pre-warmed)
Mix for a couple of minutes (approx. 3-4 minutes) will smooth
Strain through a sieve wire mesh to remove lumps.
The ready mix will keep good for about 2-3 hours.

Dough Preparation:
Wafer quality depends on the accuracy of the dough, as far as weighing and mixing are concerned. During mixing, the consistency changes due to material dissolving and swelling, gluten development and reactions with other raw material, including air. Mixing process is complete, when a certain consistency is reached, a uniform mixing that allows for a smooth flow of the dough on the baking plates. Leave the dough for minutes, and afterwards, pass it through a sieve in order to hold back the particles that have not dissolved completely. The dough will swell again. If flour with higher level of coarsely ground grain is used, the dough should be left for about 10 minutes. The longer the dough can rest; the better will be its flow. This is referred to as natural slackening of the dough. After the optimum recipe has been found out, it should be modified by the master baker.

Mixing the dough:
High Speed Mixers are best suited for beating the wafer dough Depending on the type of machine and the charge volume, the mixing period is between 3 and 10 minutes. Sufficient beating is also important for a gleaming surface of the wafer sheet without any pores.

One-stage procedure: All components, including water are portioned directly in the mixer.

Multi-stage procedure: Mix the whole dry matter with about half of the liquid. Add the remaining liquid afterwards at your own discretion, until the suspension shows adequate flow. All raw material and additives except the flour are beaten together with the remaining amount of liquid, until they are mixed thoroughly. After that, the flour is mixed in together with the remaining liquid.

Temperature: The dough should have a temperature of 20-25° C. While being prepared warmer dough tends to turn sour due to the addition of soda, if it is stored intermediately. The temperature of the pouring wafer is adjusted according to the temperature of the flour and the mixer.

Material process during mixing: The important process during mixing is dissolving and swelling of the flour components. This is decisive for the quality of the baking process and the wafer sheet and for the energy demand during baking; the water added during dough preparation has to be vaporized again during baking.

Important advice for the preparation of the wafer batter: Use smooth wheat flour with medium content of gluten.

Depending on the quality of the flour, the amount of water should be increased or decreased, as every type of flour has different soaking characteristics. In order to get a wafer sheet of good quality, the batter should not be too dilute.

Preparation of the oil/fat-lecithin emulsion: Oil/fat should be heated lukewarm Lecithin should be added slowly and stirred until it dissolves completely. The quality of the emulsion should correspond to the batter recipe used. Then it is poured into the readily prepared wafer batter and stirred.

Par-bake the sheets at 350 degrees for 10 minutes

Mandarin Pancakes (Chinese Recipe)

Ingredients:
2 cups Flour
¾ cup Boiling water
2 tbsp. Sesame oil

Directions:
Place flour in a bowl. Add boiling water, stirring with chopsticks or a fork until dough is evenly moistened. On a lightly floured board, knead dough until smooth and satiny, about 5 minutes. Cover and let rest for 30 minutes.
On a lightly floured board, roll dough into a cylinder; cut into 16 equal pieces.
Roll each piece into a ball, and then flatten slightly into a pancake, brush top of each pancake with a light coating of sesame oil.
Place 1 pancake on top of a second pancake, oiled sides together. With a rolling pin, roll to make a circle 6 inches in diameter. Stack and roll remaining pairs of pancakes the same way. Cover with a damp cloth to prevent drying.
Place a nonstick frying pan over medium heat until hot. Add 1 pair of pancakes and cook, turning once, until lightly browned and bubbles appear on the surface, about 2 minutes on each side. Remove from pan and separate into 2 pancakes while still hot. Stack cooked pancakes on a plate while cooking re pairs of pancakes.

Pancakes can be set in baking ware to form a cupped shape.

Chapatti/Roti (Indian Flat Bread Partially Baked)

Ingredients:
2.5 cups Chapatti flour with
1 cup Water at room temperature made into dough
1 cup Chapatti flour in a large plate for dusting the dough while rolling it out
Ghee for brushing bread

Method to roll dough: Prepare the desired amount of dough from the Basic Dough recipe. After resting for 2-2½ hours, knead well. Divide the dough into peach-size balls. On a lightly floured surface, flatten one ball of dough with your hand. Using a rolling pin, roll out the dough into a thin, round patty, about 5 inches in diameter. Roll from the center, turning patty several times to prevent sticking Try to make the edges slightly thinner than the center. As you cook the chapatti/roti one could be rolling out the next, rather than shaping all of the chapattis at one time. Preheat a cast-iron tawa over medium heat. Place the rolled dough on the palm of one hand and flip it over on to the tawa. When the color changes on the top and bubbles appear, it will be partially baked. Use kitchen tongs (chimta) to remove the chapatti from the skillet.

Chapatti can be compressed into baking ware to form cups.

Chapatti/Roti Substitutes (Partially Baked)

Wheat and malted barley flours

Use equal parts of whole-wheat flour and all-purpose flour OR use equal parts of malted barley and all-purpose flour

Cornmeal Crepes (Par-Baked)

Ingredients:
1 cup Cornmeal
½ tsp. Salt
½ cup Flour
1 Egg
2 cups Water
Additional egg content may be added to increase flexibility of the par-baked product.

Mix ingredients together and warm a pan with butter.

Pour batter into pan half a ladle at a time.

Partially cook.

Cornmeal Crepes will take the form of the baking cups, once pressed within the baking ware.

Edible Wafer Liners

Liners are dried, not baked.

Ingredients:
80% Potatoes
15% Water
5% Rapeseed oil
Inks:
Propylene glycol
FD and C yellow #5 and #6
Red #3 and #40
Blue #1
Certified FDA colors

Mix the ingredients, roll into sheets, and dry.

Pita Bread (Partially Cooked)

Ingredients:
3½ cups (875 ml) All-purpose flour
1 cup (350 ml) Water
1 Tbs (15 ml) Olive oil
2 Tbs (10 ml) Salt
1½ tsp (7 ml) Instant yeast

Directions: Combine all ingredients in electric food processor, adding a little more water or flour if necessary to form a slightly sticky ball. Turn onto floured surface and knead for 1 minute. Place in a greased bowl cover loosely with a towel and allow to rise until doubled in volume, about 2 hours. Punch down and divide into 6 to 12 pieces. Keep pieces lightly floured and covered. Flatten each piece into a 6″ to 8″ disk in diameter. Place on baking stone or sheet that has been heated in a 500° F. (260° C.) oven for 1 minute to par-bake. Pieces will then be pressed into cup forms.

Naan (Flat Bread from India) (Par-Baked)

Servings 14 pieces

Ingredients:
0.25 oz Active dry yeast
4 tbsp White sugar
1 cup Warm water
1 Beaten egg
3 tbsp Milk
2 tsp Salt
Additional egg content may be added to increase product flexibility.

Preparation: In a large bowl dissolve yeast in warm water. Beat until frothy. Stir in sugar, milk, egg, salt, and enough flour to make a soft dough Knead for 6 minutes on a lightly floured surface, or until smooth. Place dough in a well-oiled bowl cover with a damp cloth, and set aside to rise. Let it rise until the dough has doubled in volume. Pinch off small amounts of dough to make 12 to 14 pieces. Roll into balls, and allow to rise again While the dough is rising, preheat the grill to high. At grill side, roll one ball of dough out into a thin circle. Lightly oil the grill. Place dough on grill, and cook for 1½ minutes. Brush uncooked side with butter, and cook until done, another minute to par-bake. Press into baking ware and cook according to your baked goods recipe.

Lefse Norwegian Flat Bread) (Par-Baked)

16 to 18 rounds

Ingredients:
3 cups Boiling water
½ cup Butter flavored shortening
1 cup Evaporated milk
1 tsp Salt
2 tsp White sugar
3 cups Dry potato flakes
3 cups All-purpose flour
¾ cup Wheat flour

Directions:
In a large bowl mix together the boiling water, shortening, milk, salt, sugar, and potato flakes. Place in the refrigerator until thoroughly chilled.
After dough is thoroughly chilled, add the flour, using a pastry blender to cut in. Divide dough into 3 equal size portions. Form into 3 logs. Chill thoroughly in the refrigerator.
Heat an electric griddle to 375° F. (190° C.).
Divide logs into 8 pieces. Roll to about the size of a 10-inch tortilla. Work additional flour into rounds as needed. Use care to press lightly with rolling pin when forming into rounds as they are much more tender than pie dough. The weight of a large rolling pin is nearly enough. Partially bake on griddle turning frequently, to dry slightly. Cool on clothe Cover with an additional cloth. Stack pieces on top of each other as they are baked. The steam will create a more tender product. The pieces can be compressed to take on a cupped shape filled with batter and baked according to batter recipe.

Obviously, numerous modifications and variations of the present invention are possible in light of the above teachings. It is therefore understood that within the scope of the appended claims, the invention may be practiced otherwise than as specifically described herein.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. An interlocking cake sideliner comprising:
a) a sheet of bakeable edible substrate having at least four sides, including a top edge, a bottom edge, a first end and a second end, the first end having a first interlocking member and said second end having a second interlocking member that is interlockable with said first interlocking member to form a continuous loop;
b) the bakeable edible substrate having sufficient integrity to be freestanding when formed into a continuous loop so as to receive a bakeable substance within an area bounded by the continuous loop;
c) the bakeable edible substrate being suitable to be baked onto a bakeable substance received within the area bounded by the continuous loop that is baked together with the bakeable edible substrate to formed a baked substance, wherein the bakeable edible substrate forms a sidewall of the baked substance after the bakeable substance is baked together with the bakeable edible substrate.

2. The interlocking cake sideliner of claim 1, wherein the flat sheet has a first interlocking member that is one of a male and a female member and the second end has a second interlocking member that is the other of a male and a female member and is interlockable with said first interlocking member.

3. The interlocking cake sideliner of claim 1, wherein the flat sheet has a thickness of about 1/20 inch to about ⅛ inch.

4. The interlocking cake sideliner of claim 1, wherein the flat sheet has a distinguishable scene printed thereon in bakeable edible print, which distinguishable scene is transferred to a side of the baked substance after the bakeable substance is baked together with the bakeable edible substrate.

5. The interlocking cake sideliner of claim 4, wherein the sideliner further includes an edible topping decoration that is complimentary to said distinguishable scene.

6. The interlocking cake sideliner of claim 1, further comprising a separate bakeable edible substrate bottom having a shape and size compatible with an open bottom created when the bakeable edible substrate is formed into a continuous loop.

7. The interlocking cake sideliner of claim 6, wherein the sheet of bakeable edible substrate and the bottom have interlocking features that are complimentary.

8. The interlocking cake sideliner of claim 1, wherein the bakeable edible substrate is an edible film wrap.

9. The interlocking cake sideline of claim 1, wherein the bakeable edible substrate is flavored.

10. The interlocking cake sideline of claim 1, wherein the bakeable edible substrate is non-flavored.

11. A method of making a cake product comprising:
a) providing a flat sheet of bakeable edible substrate being a sideliner including a top edge, a bottom edge, a first end and a second end;
b) joining said first and second ends to form a continuous loop and placing said sideliner on a bakeware device, the sideliner being capable of being filled while placed on the bakeware device;
c) pouring bakeable cake material into said sideliner on said bakeware device and baking said sideliner and said cake material together until the bakeable cake material is baked;
d) wherein the sideliner is baked onto the baked cake material.

12. The method of claim 11, wherein said first end has a first interlocking member and said second end has a second interlocking member that is interlockable with said first interlocking member to form the continuous loop.

13. The method of claim 11, wherein said flat sheet has a thickness of about 1/20 inch to about 1/16 inch.

14. The method of claim 11, wherein said flat sheet has a distinguishable scene printed thereon in bakeable edible print.

15. The method of claim 11, further providing a separate bottom formed from the flat sheet of bakeable edible substrate having a shape and size compatible with an open bottom created when said first and second ends are joined to form a continuous loop, said separate bottom being joined with said sideliner to form an edible baking cup.

16. An edible sideliner comprising:
a) a sheet of bakeable edible substrate formed into a continuous loop;
b) the bakeable edible substrate having sufficient integrity to be freestanding when formed into a continuous loop so as to receive a bakeable substance within an area bounded by the continuous loop;
c) the bakeable edible substrate being suitable to be baked onto a bakeable substance received within the area bounded by the continuous loop that is baked together with the bakeable edible substrate to formed a baked substance, wherein the bakeable edible substrate forms a baked-on sidewall of the baked substance after the bakeable substance is baked together with the bakeable edible substrate.

17. The cake sideliner of claim 16, wherein the sheet of bakeable edible substrate has a distinguishable scene printed thereon in bakeable edible print, which distinguishable scene is transferred to a side of the baked substance after the bakeable substance is baked together with the bakeable edible substrate.
